(19) United States
(12) Patent Application Publication
(10) Pub. No.: US 2005/0115376 A1
(43) Pub. Date: Jun. 2, 2005

(54) Jig for cut-off saw

(75) Inventor: Rojelio R. Jimenez, Carlsbad, NM (US)

Correspondence Address: FITCH EVEN TABIN AND FLANNERY, 120 SOUTH LA SALLE STREET, SUITE 1600, CHICAGO, IL, 60603-3406, US

(73) Assignee: Industrial Solutions LLC

(21) Appl. No.: 10/700,125

(22) Filed: Nov. 3, 2003

Related U.S. Application Data
(63) Continuation of application No. 09/218,709, filed on Dec. 22, 1998, now abandoned.
(60) Provisional application No. 60/068,550, filed on Dec. 23, 1997.

(51) Int. Cl. B26D 7/02

(52) U.S. Cl. 83/464; 83/466; 83/468.3

(57) ABSTRACT

A jig for holding a workpiece on a cut-off saw includes a work-engaging wall adapted to extend transversely to a support table of the saw and be disposed between a backup plate and clamping plate of the saw. A guide pin secured to the work engaging wall extends into a guide groove on the support table, and an angle-setting projection, which can be adjustable, on the work-engaging wall extends toward the backup plate on the table to set the angle at which the workpiece is cut by the saw.

### BACKGROUND OF THE INVENTION

This invention relates to jigs adapted to be used with power cut-off saws of the type shown in U.S. Pat. No. 5,483,858 to Chen (1996), which have clamping mechanisms for holding a piece of work on a support table of a saw.

A typical prior art power saw has an adjustable backup plate, which can be set at different angles with respect to the cutting plane of the saw to permit pieces of work to be sawed off at various angles to the longitudinal axis of the work. Normally the backup plate is set so that the work is cut at 90° to the longitudinal axis of the work, and must be adjusted when work is to be cut at some other angle.

The jig of this invention quickly and easily fits on the support table of a conventional saw so that work may be held and cut off at any desired angle without having to adjust the position of the backup plate on the saw. This reduces typical cutting time from about three or four minutes to less than 30 seconds.

### BRIEF DESCRIPTION OF THE DRAWINGS

FIG. 1 is a perspective view of an embodiment of a jig in accordance with the present invention;

FIG. 2 is a plan view of the jig shown in FIG. 1;

FIG. 3 is a view taken on line 3-3 of FIG. 2;

FIG. 4 is a plan view of an alternate embodiment of a jig in accordance with the present invention;

FIG. 5 is a view taken on line 5-5 of FIG. 4;

FIG. 6 is a view taken on line 6-6 of FIG. 4;

FIG. 7 is a perspective view of another embodiment of a jig of this invention, with a workpiece mounted in the jig;

FIG. 8 is a fragmentary perspective view of the jig showing the use of a gauge plate to position the workpiece in the jig;

FIG. 9 is a fragmentary perspective view of the jig shown in FIG. 8 showing how the workpiece is rotated 180° to position it for a second cutting;

FIG. 10 is a perspective view of a workpiece after it has been cut twice to form a saddle to fit over a second workpiece;

FIG. 11 is a fragmentary perspective view of another embodiment of the jig of this invention mounted on a cutoff saw table and with a workpiece clamp in position for cutting;

FIG. 12 is a perspective view of yet another embodiment of the jig of this invention;

FIG. 13 is a plan view of an embodiment of the jig of this invention using an adjustable stop for setting the angle at which a workpiece is presented to the cutoff saw;

FIG. 14 shows separate elements of another jig of this invention using an adjustable plate for setting the angle at which a workpiece is presented to the cutoff saw; and

FIG. 15 is a plan view of the jig of FIG. 14 assembled to hold a workpiece at a 45° cutoff angle.

### DETAILED DESCRIPTION OF THE PREFERRED EMBODIMENTS OF THE INVENTION

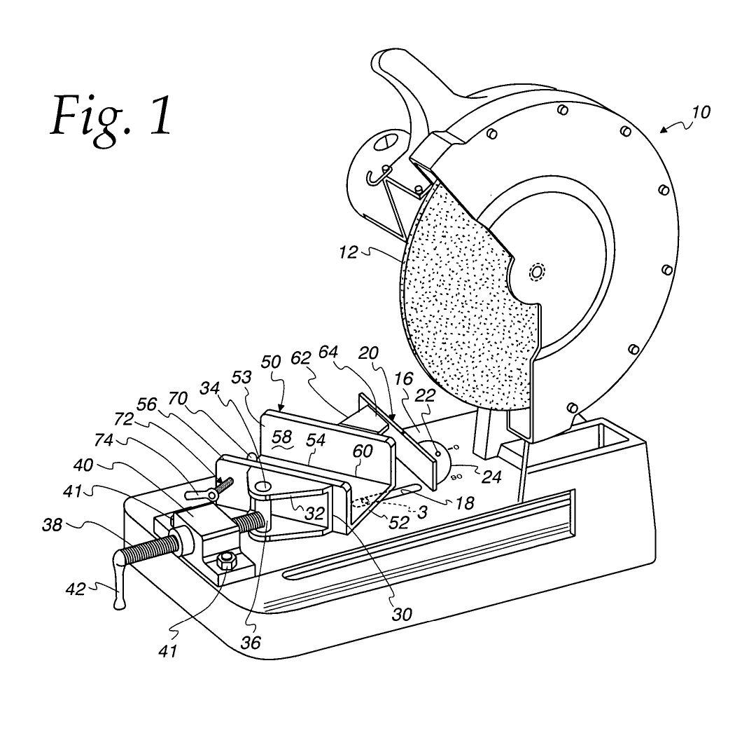

Referring to FIG. 1, a conventional circular saw 10 includes a cutting blade 12 which rotates in a cutting plane that contains the major plane of the saw blade, and is perpendicular to the axis of rotation of a horizontal shaft 14, which supports the blade.

The saw also includes a horizontal support table 16 with an upwardly opening elongated guide groove 18 extending substantially parallel to the cutting plane of the saw, and extending vertically through the saw support table.

A vertical backup plate 20 is mounted on the support table to pivot about a vertical shaft 22 extending through an adjusting mechanism 24, which can be locked in various positions for work to be cut by the saw.

A vertical table clamping plate 30 is secured by a bracket 32 to pivot about a vertical shaft 34 which extends down through a sleeve 36 secured at its upper and lower ends to the bracket. The forward end of a horizontal and longitudinally extending clamping screw 38 is threaded through a pillow block 40 secured by bolts 41 to the support table. A handle 42 on the rear end of the clamping screw permits the table clamping plate 30 to be moved toward and away from the backup plate 20.

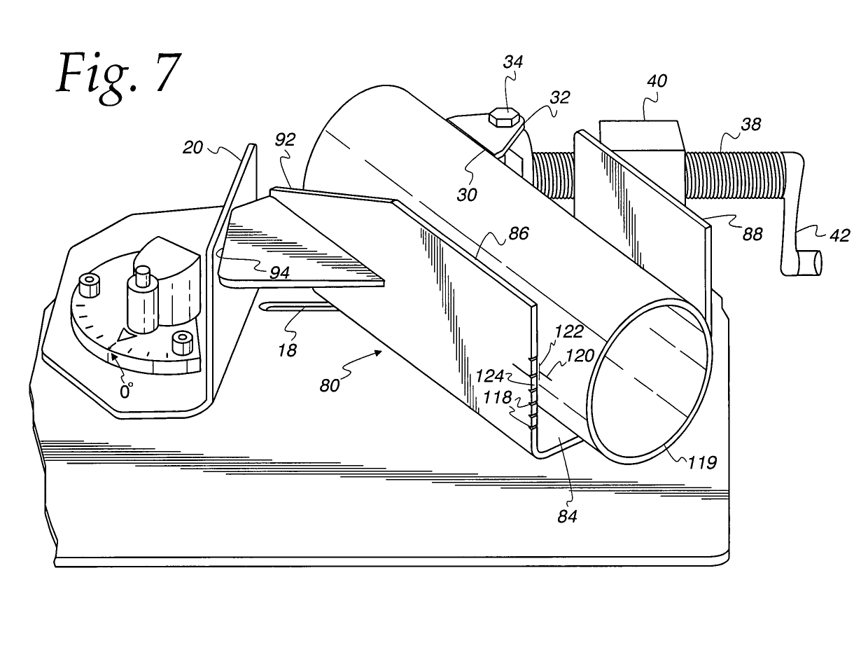

A jig 50 of this invention includes a horizontal and rectangular base plate 52 and an upright work engaging front wall 53 having a lower edge secured to the forward edge of the base plate at 54. An upright rear wall 56 is secured at its lower edge to the rear edge of the base 52. The front wall includes a substantially vertical work surface 58 lying in a major plane substantially parallel to the longitudinal axis of an elongated piece of work (not shown in FIG. 1) on the base plate of the jig as shown in FIG. 7.

The jig base plate 52 rests on the support table 16, and a vertical guide pin 60 welded to the bottom of the base plate extends down into the guide groove 18 to make a close sliding fit within the groove.

An angle-setting projection 62 (in the form of a horizontal plate with four non-parallel sides) welded to the forward face of the front wall extends toward the backup plate 20. An aligning surface 64 on the forward end of projection 62 faces the backup plate, and lies in a vertical plane at an angle to the major plane of the work surface 58 of the front wall.

A work clamp 70 is secured to the forward end of a horizontal screw 72, the rear end of which carries a handle 74. The screw 72 is threaded through the left (as Viewed in FIG. 1) end of the rear wall 56 so a piece of work (not shown in FIG. 1) can be clamped within the jig between the front and rear walls.

The jig shown in FIGS. 1-3 is used by placing the jig in the position shown in FIG. 1, and thereafter placing an elongated pipe (not shown) or other piece of work having a central longitudinal axis (not shown) in the jig and clamping the work in the jig with work clamp 70. The table clamping plate 30 is then adjusted to drive it forward against the rear wall 56 of the jig, causing the guide pin 60 to slide forward (to the right as viewed in FIG. 1) until the aligning surface 64 along the forward edge of the angle-setting projection 62 contacts the backup plate, which is set in the 0° position so that the backup plate 20 is perpendicular to the cutting plane of the saw. The angle of the aligning surface 64 with respect to the work surface 58 of the forward wall of the jig and causes the jig and clamping plate 30 to rotate in a counterclockwise (as viewed from above) direction around the guide pin 60 and vertical shaft 34 until the clamp 30, jig, work, and angle-setting projection are all firmly locked in the position shown in FIG. 1. The angle between the aligning surface 64 and the major plane of work surface 58 can be any desired amount. However, 30° is a good angle for forming a saddle 74 on the end of a pipe 75 or cylindrical tube so the end of the pipe with a saddle makes a snug fit perpendicular to a similar piece of tubing 76 as shown in the phonograph of FIG. 10, The saddle is formed by first cutting the pipe or tubing at an angle of 30° thereafter rotating the pipe in the jig 180° about the longitudinal axis of the pipe, and making a second cut at 30°.

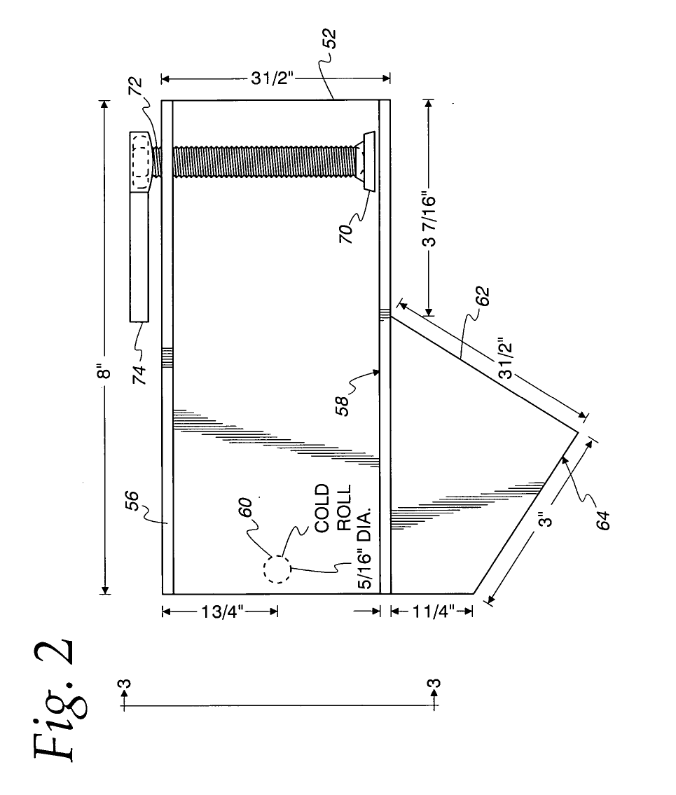

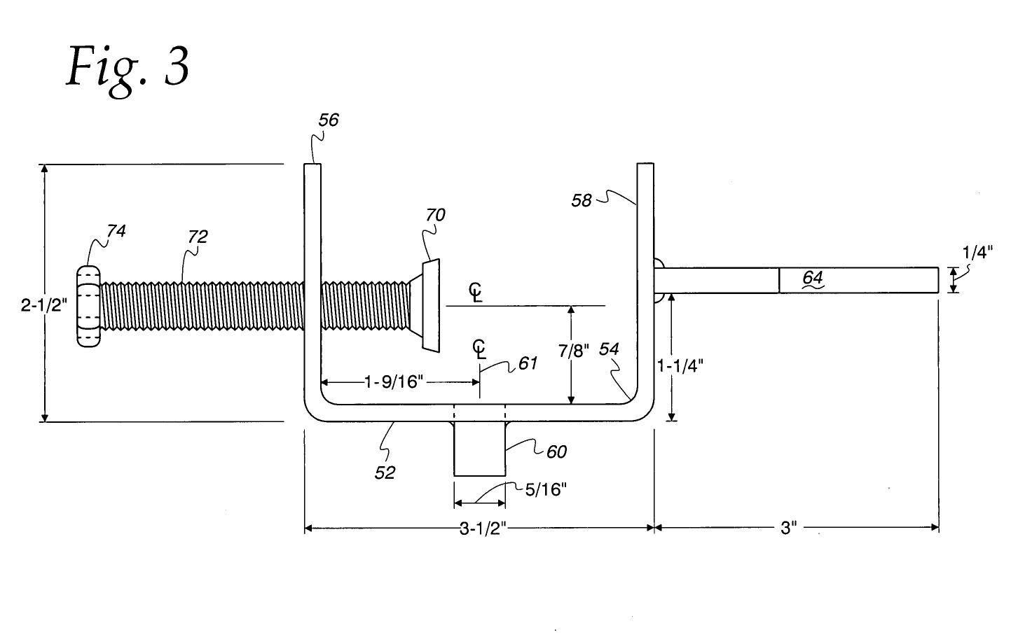

Typical dimensions of the jig are as shown on FIGS. 2 and 3, which also show that the jig base plate 52, rear wall 56, and forward wall 58 are conveniently formed by bending a single piece of rectangular plate into a U-shape.

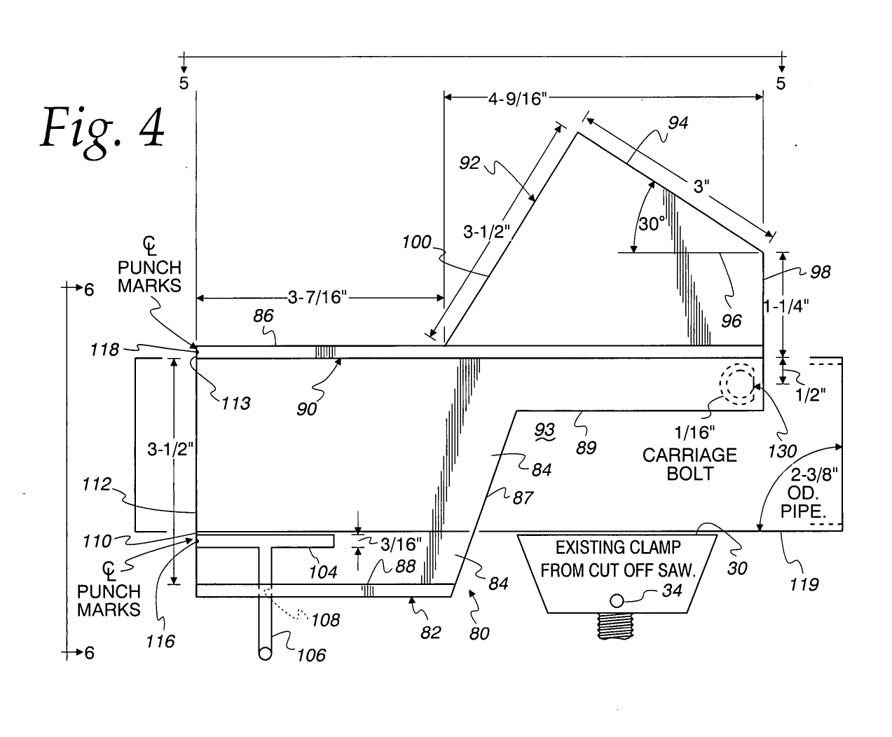

An alternate embodiment of the invention is shown in FIGS. 4-9. Referring to FIGS. 4-7, a jig 80 includes a U-shaped body 82 having a horizontal base 84, and vertical front and rear parallel walls 86 and 88, respectively, each formed integrally along its respective lower edge with forward and rear edges of <the base. A portion of the right and rear part of the base is cut away along lines intersecting 87 and 89 to leave a notch 93 which opens to the rear and right (as viewed in FIG. 4) of the base. The portion of the base forward of line 89 extends to the right to be coterminous with the right edge of the front wall 86. The right (as viewed in FIG. 4) half of the rear wall 82 is also cut away along a vertical plane which includes line 87.

The rear face 90 of the front wall forms a work-engaging surface 91 against which a piece of elongated work bears as described below.

A forwardly extending angle-setting projection 92 in the shape of a horizontal plate is welded to the forward face of front wall 86. As shown best in FIG. 4, projection 92 includes an aligning surface 94 which extends rearwardly and to the right (as viewed in FIG. 4) with respect to the major plane of front wall 90 at an angle of 30°, as shown by phantom line 96. The projection 92 includes a right edge 98, which is perpendicular to the major plane of front wall 90 and extends forward from the front wall for a distance of about equal to about one-half the distance between the front and rear walls of the jig. The rear end of aligning surface 94 begins at the forward end of edge 98. The forward end of aligning surface 94 makes a right angle with a trailing edge 100, which extends from the forward end of aligning surface 94 to the forward surface of front wall 86. The angle-setting projection is welded to the front face of the forward wall.

A vertical gauge plate 104 (FIGS. 4 and 6) is between and parallel to the front and rear walls of the jig. The gauge plate is substantially square, and is welded to the forward end of a horizontal rod 106, which makes a close sliding fit through a bore 108 in the left (as viewed in FIG. 4) end of the rear wall 82. As shown best in FIG. 4, the vertical left edge 110 of the gauge plate is coplanar with the vertical left edge 112 of the base 84 and the vertical left edge 113 of front plate 86. The left (as viewed in FIG. 4) edges of the gauge plate 104 and front wall 86 each carry index marks 116 and 118, respectively, to indicate the center line of various size pipes or tubing placed to rest on the base 84 of the jig.

As shown in FIGS. 4 and 7, and described above, the right half of the rear wall 88 and the base 84 are cut away so the table clamping plate 30 can engage the workpiece (pipe or tubing) 119 directly, and clamp it against the rear face 90 of the front wall in the cutting position shown in FIG. 7. The guage plate and rod 106 are not shown in FIG. 7. The pipe or tubing is marked with a soap stone marker (not shown), or other suitable device, to provide a horizontal line 120 (FIG. 7) which lies in a horizontal plane passing through the longitudinal central axis of the pipe. The pipe is also marked with a substantially vertical line 122, which lies in a plane that contains the left edge 124 of the front wall 86. The right end of the pipe (i.e., the end of the pipe adjacent the table clamping plate 30) is sawed off at the angle (say, 30°) set by the aligning surface 94 on projection 92 secured to the forward face of front wall 86 of the jig 50. The pipe or tubing is then released from the table clamp, and rotated 180° around its longitudinal axis so that the longitudinal mark 120 lines up with the appropriate mark on the left edge of gauge plate 104, and so that mark 122 lies in the same plane as the left edge of rear plate 88. The table clamp is reset to hold to the pipe firmly in the jig and so that jig is clamped against the backup plate 20. Thereafter, the pipe is cut a second time. If the pipe has been cut at an angle of 30° each time, it forms a perfect saddle to fit on a pipe of similar diameter so it can be welded in position as shown in the photograph of FIG. 10.

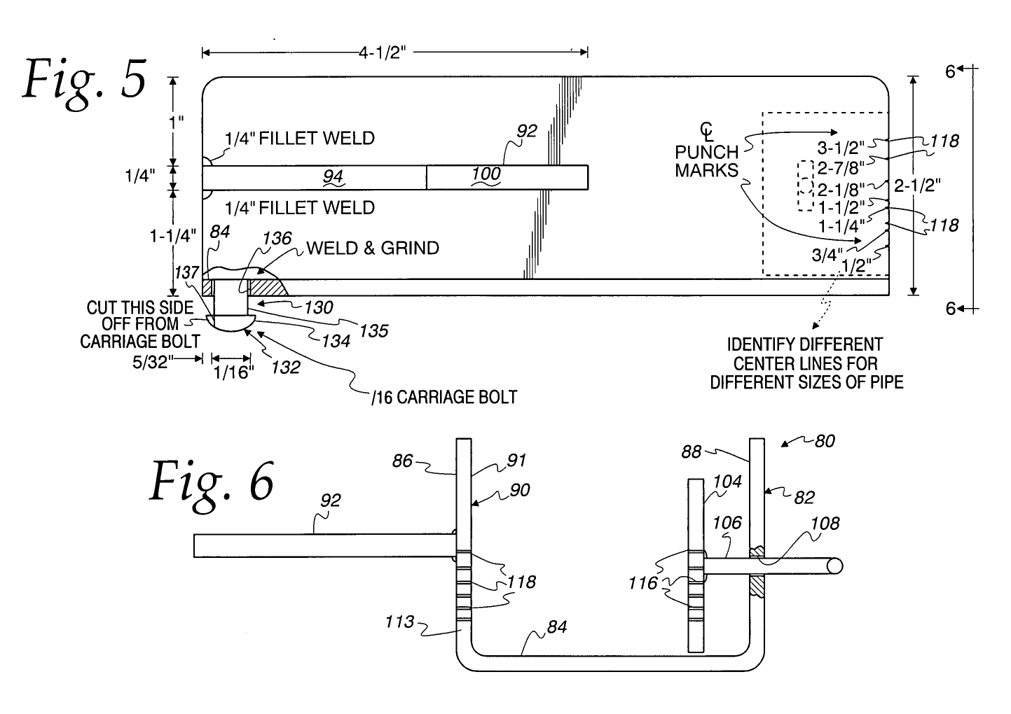

As shown best in FIGS. 4 and 5, a guide pin 130 extends downwardly from the right front edge of base 84. Conveniently, the guide pin is a carriage bolt 132 having a head 134 and an upwardly extending shank 135 disposed in a bore 136 extending through the base 84. The upper end of the bolt shank is welded in the bore 136 to be substantially flush with the top surface of the base. The upper end of the bolt shank and the surrounding base 84 are ground to a flat finish. The carriage bolt can be of any convenient size. A 5/16″ carriage bolt has a shank which fits in the guide groove 18 (FIG. 1) of most power saws. The right (as viewed in FIG. 4) side 137 of the bolt head is cut off to be flush with the right edge of the shank and lying in a vertical plane as shown in FIGS. 4 and 5. This permits the guide pin 130 to be fitted into most guide slots or cut-off saws by simply rotating and tilting the jig. The guide pin is easily removed when desired by reversing those steps. Other retaining means can be used on the lower end of the guide pin. For example, the bolt head can be of any shape which has a horizontal dimension greater than and transverse to width of the guide groove 18 when the jig holds the workpiece in cutting position, and which has a horizontal dimension less than and transverse to the guide groove when the jig is rotated so the front plate is perpendicular to the guide groove.

In another embodiment of the jig of this invention, the entire base and rear wall can be omitted, and the guide pin 130 can be secured to the lower edge of the front plate. With this arrangement the work piece rests and slides on the support table 16 as the work piece is moved into position for cutting.

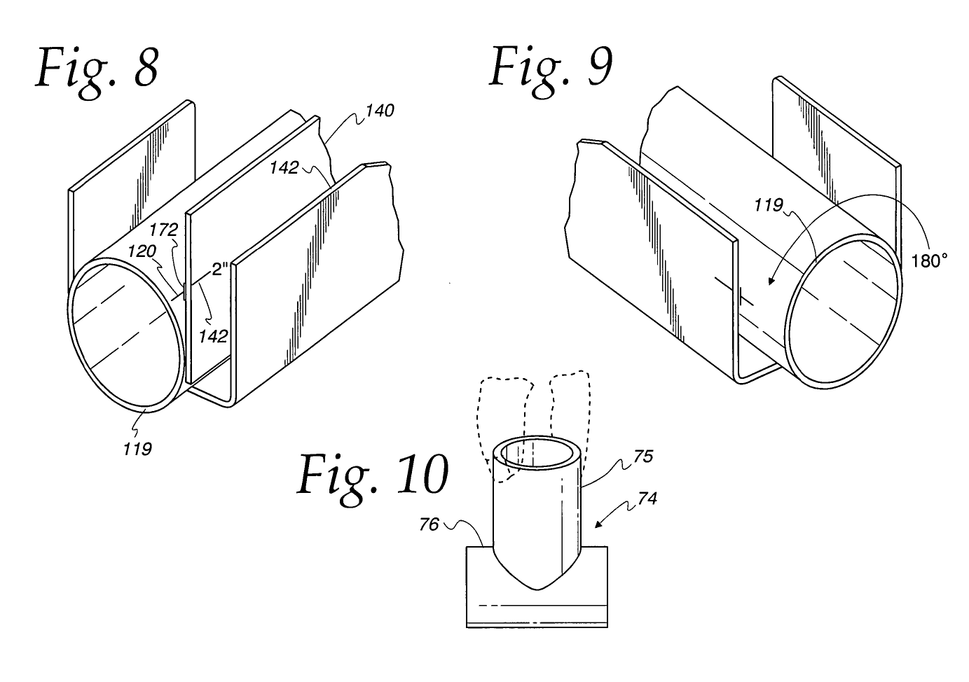

As shown in FIGS. 8 and 9, if desired, the gauge plate 104 and rod 106 of the embodiment shown in FIGS. 4, 5 and 6 can be omitted and replaced by a gauge card or plate 140, say, a thin square plate about 3×3 inches. As indicated above, the entire rear wall of the jig may also be omitted. The edges of the gauge card are provided with indexing marks 142 for pipes of various diameters. For example, FIG. 8 shows a 2″ pipe with marks 120 and 122 previously applied and rotated 180° so that the longitudinal mark 120 lines up with the 2″ index mark on the gauge card, and so that the vertical mark 122 lines up with the left edge of the card gauge, which lies in the plane defined by the left edges of the base and front wall of the jig.

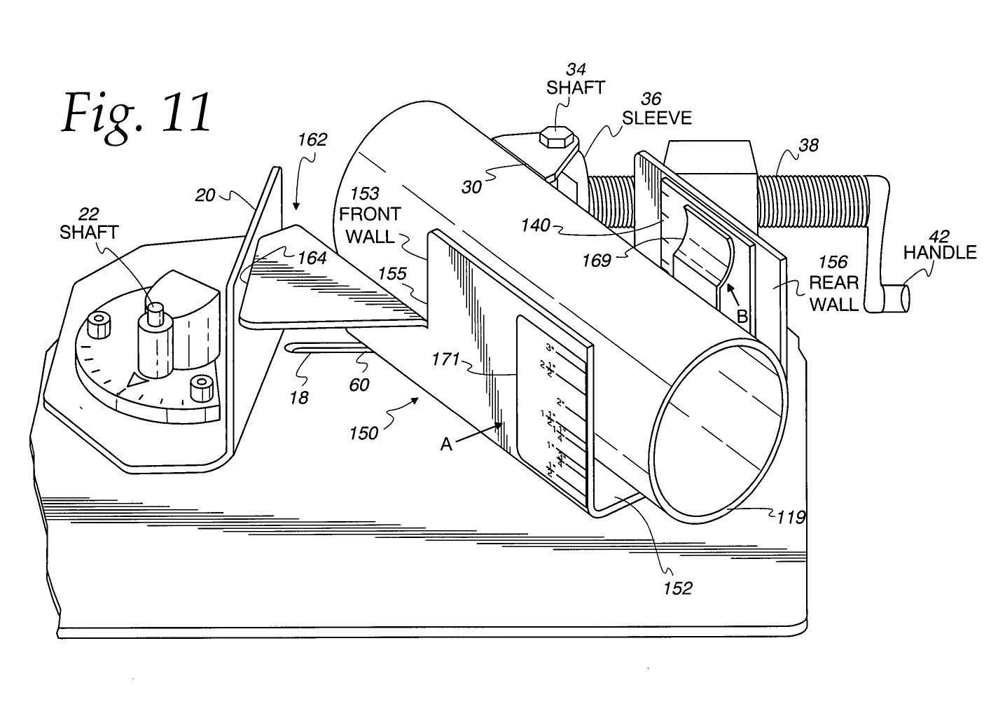

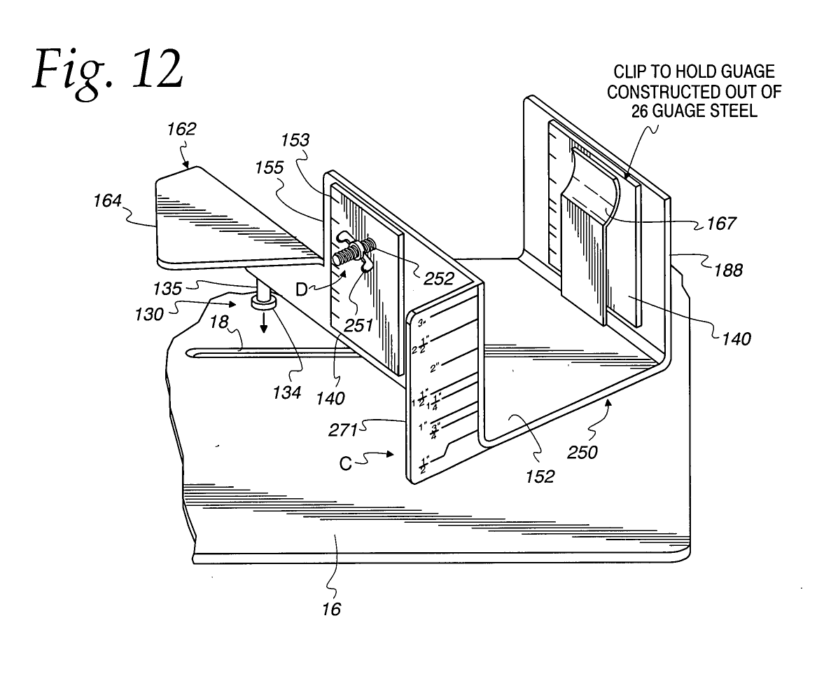

FIG. 11 shows in perspective an alternate embodiment of a jig 150, which is similar to the jig shown in FIG. 7, except that an angle-setting projection 162 is formed integrally with a front wall 153, which is cut vertically at 155 from the upper edge of the front wall 153 down to about the mid point of the height of the front wall. The angle-setting projection 162 is bent forward to present a horizontal aligning surface 164, which is cut to position the jig at the desired angle for cutting the workpiece 199, which is clamped firmly against the work engaging front wall 153 by the clamping plate 30.

A flexible clip 169 is welded at its lower edge (shown only in FIG. 12) to the lower edge of the rear wall. The clip 169 permits the gauge plate 140 to be stored in a convenient location when not in use.

A gauge label 171 is mounted on the forward face of the front wall to provide a series of vertically spaced horizontal marks indicating the center line of various tubular workpieces having a diameter from one half inch to three inches. This facilitates marking the tubing as previously described to facilitate rotating at 1000 to the proper position for making a second cut to form a saddle at the cut end of the tubing.

Elements shown in FIGS. 11-13 corresponding with those shown in FIGS. 1-9 are given corresponding reference numerals, and those elements are not described again with respect to FIGS. 11-13 for simplicity.

The jig 250 shown in FIG. 12 is almost identical to that shown in FIG. 11, except that a vertical gauge plate 271 perpendicular to the front wall is welded to the left end of the forward wall 153, and includes vertically spaced horizontal indexing marks to show the center line of the tubular workpieces placed in the jig and having a diameter between one half inch and three inches. This facilitates marking the center line of the workpiece as described above. The jig of FIG. 12 also includes a clip 169 welded to the forward face of the rear wall 188 for holding the gauge plate 140. Alternatively, the gauge plate may be secured to the forward face of the front wall 153 by a wing nut 251 threaded onto a horizontal screw 252 welded to the forward face of the front wall. A hole 253 through the gage plate permits the plate to be slipped on and off the screw 252. Alternatively, the gauge plate 140 can be secured to the rear face of the rear wall 188 by similar wing nut and screw combination (not shown).

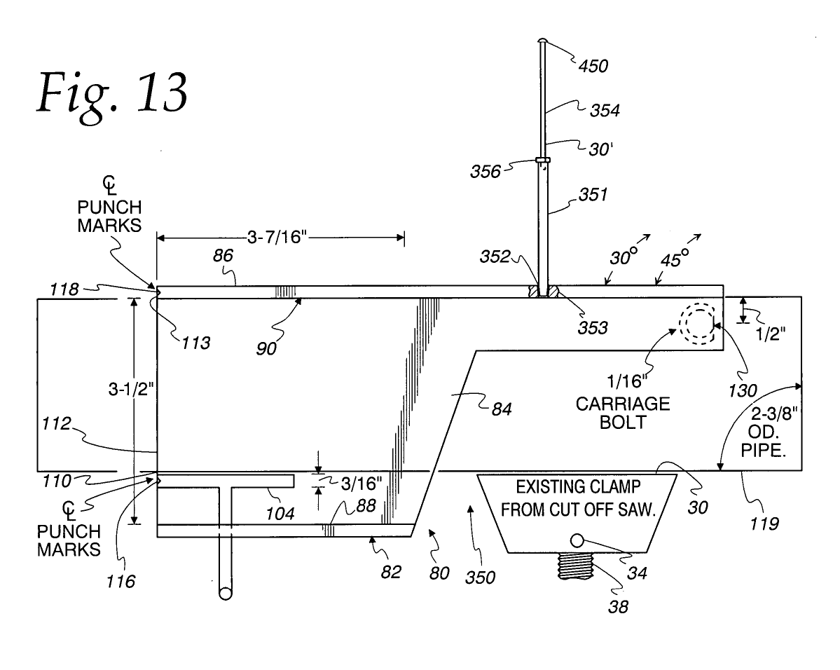

The jig 350 shown in FIG. 13 is similar to that shown in FIG. 4, except that the plate forming the angle-setting projection 92 is omitted, and replaced by an internally threaded horizontal sleeve 351 secured at its rear end by external threads 352 in an internally threaded socket 353 in the front wall 90. The sleeve is perpendicular to, and extends forward from the front wall. A screw 354 is threaded into the sleeve to provide an adjustable angle-setting projection, which can be locked in any desired position by a locking nut 356, which can be tightened to bear against the forward end of sleeve 351. With the screw 354 in its most extended position, as shown in FIG. 13, it and the right end of the front wall form an angle-setting projection which holds the longitudinal axis of the workpiece at an angle of 45° with respect to the cutting blade of the cutoff saw. With the screw 334 threaded fully into sleeve 351, the forward end of the screw and the right end of the front wall form an angle-setting projection at an angle of 30° between the longitudinal axis of the workpiece and the major plane of the saw blade. The screw is provided with suitable marks or color coding (not shown) to facilitate setting it in the correct position for any desired angle between 30° and 45°. For smaller angles, the sleeve shown in FIG. 13 is replaced by a shorter sleeve and screw (not shown) of similar construction. The remaining elements of the jig shown in FIG. 13 are given reference numerals corresponding to those of corresponding elements in FIG. 4, and the detailed description of those elements is not repeated here for simplicity.

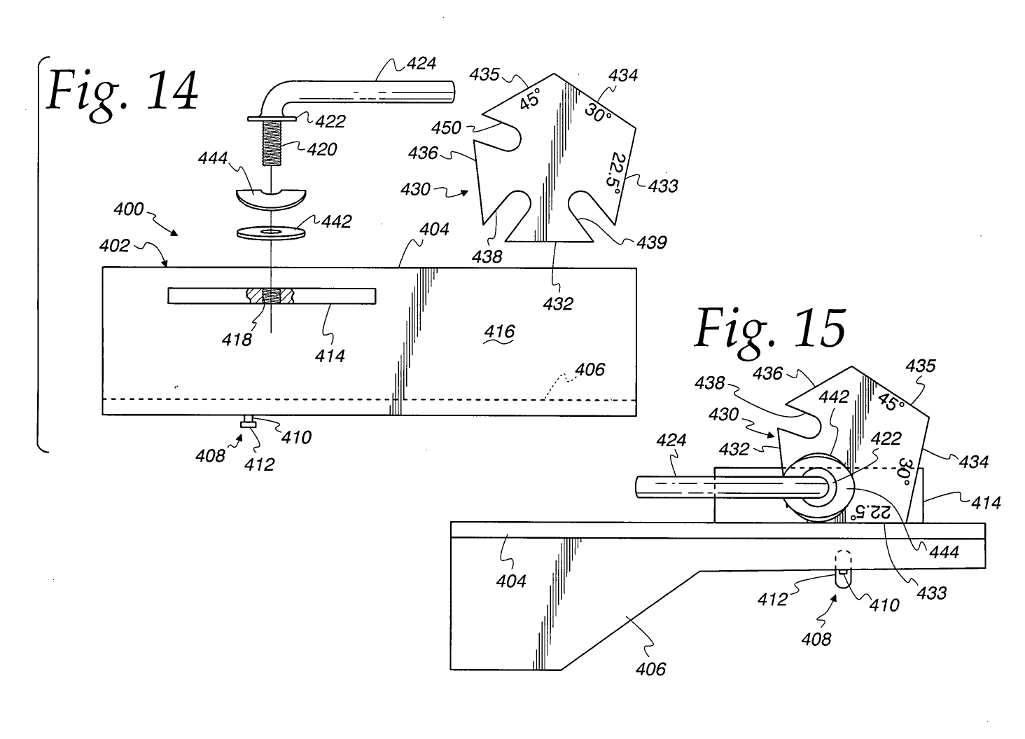

FIG. 14 shows the various elements of another jig 400 of this invention, which includes a jig body 402 having a vertical front wall 404 and a horizontal base 406, which has the same shape as the base 84 for the jig shown in FIG. 4. A downwardly extending guide pen 408 is welded to the lower surface of the base 406, and includes a downwardly extending shank 410 which terminates at its lower end in a head 412 in the shape of an elongated rectangle with the longer dimension of the rectangle perpendicular to the front wall. The width of the rectangle is slightly less than the guide groove on the support table of the saw so the guide pin 408 will fit down into the guide groove 18 when the front wall is perpendicular to the elongated axis of the guide groove. As the jig is rotated counterclockwise (as viewed in FIG. 15) to position a workpiece for cutting at a proper angle, the elongated head 412 of the guide pin 408 is rotated so that it makes a close fit against the under surface of the support table adjacent the guide slot, and thus locks the jig to the support table as the workpiece is cut.

A horizontal shelf 414 is welded to the forward face 416 of the front wall 404, and includes an internally threaded vertical bore 418 adapted to receive an externally threaded screw 420 with an outwardly extending circular stop 422 at the upper end of the screw. An elongated horizontal handle 424 is secured at one end of the upper end of the screw to facilitate tightening the screw in the internally threaded bore 418.

A flat angle-setting projection plate 430 is adapted to rest on the top surface of the shelf 414 as shown in FIG. 15. The projection plate is in the shape of a pentagon having first, second, third, fourth and fifth sides 432, 433, 434, 435, and 436, respectively. As shown in FIG. 15, the angle-setting projection plate 430 is secured to the top surface of a shelf 414 with the second side 433 bearing against the forward surface 416 of the front plate 404. A pair of inwardly extending first and second slots 438 and 439 are formed in the plate 430 at opposite ends of the first side 432. The inner end of each slot is semi circular to make a close fit around the externally threaded screw 420. A load washer 442 rests on the plate 430 over the second slot 349, and a lock washer 444 rests on the load washer. The screw 420 extends down through the tube washers and is threaded in the bore 418 as shown in FIG. 415. Handle 424 is used to tighten the screw 420 so the plate 430 is clamped firmly in place on the shelf so that the forward most portion of the plate 430 is the apex formed by adjacent portions of the third and fourth sides 434 and 435, respectively. The interior angle between the second side 433 and the fourth side 435 is 45° so that when the jig and workpiece (not shown) are advanced to the cutting position, the jig rotates as described above in a counterclockwise direction until the fourth side 435 of the plate 430 fits against the backup plate on the support table of the saw. A workpiece is then in position for being cut at a 45° angle. If a 30° cut is required, the screw 422 is loosened, the plate 430 is pulled out, rotated counterclockwise (as viewed in FIG. 15) until the first slot 438 is aligned over internally threaded bore 418 and fits around the screw 420, which is then tightened to clamp the projection plate 430 with the first side 432 fitting firmly against the forward face 416 of the front plate 404. With the projection plate in this position, the most forward point of the plate is the apex between the third and fourth sides 434 and 435, respectively. The third side 434 makes an interior angle of 30° with the first side 432 so that with the plate 430 mounted as just described, a workpiece can be cut at an angle of 30°. A cut at an angle of 22.5° is made by positioning the fifth side 436 against the forward face of the front plate, and aligning a third slot 450 formed in the plate 430 between adjacent fourth and fifth sides 435 and 436, respectively, around the screw. With the plate clamped in that position, the forward most part of the projection plate 430 is the apex formed by the second and third sides 433 and 434, respectively. The interior angle between the second side 433 and the fifth side 436 is 22.5°. For convenience, the plate is labeled adjacent the second, third and fourth sides to indicate the angle of the cut made when those sides are parallel to the backup plate on the support table of the saw.

From the foregoing description of the various jigs, it will be clear that the present invention provides a quick and economical way of supporting elongated workpieces in a cutoff saw for cutting workpieces at various angles.

1. A jig for holding a work piece on a cut-off saw having a work support table with an elongated guide groove, a backup plate mounted on the table, a table clamping plate spaced from the backup plate, and a table clamp for moving the table clamping plate toward and away from the backup plate, the jig comprising:
a work-engaging wall adapted to and extend transversely to the support table between the backup plate and the table clamping plate;
a guide pin secured to the work-engaging wall and adapted to extend into the guide groove on the table; and
an angle-setting projection on the work-engaging wall, and extending toward the backup plate on the table so when the work piece is between the work-engaging wall and the clamping plate, the angle-setting projection is forced into contact with the backup plate as the table clamp moves the table clamping plate toward the backup plate to hold the jig in a cutting position.

2. A jig according to claim 1 which includes a retainer on the guide pin to engage the support table and prevent the jig from being removed from the support table when the jig is in the cutting position.

3. A jig according to claim 1 or 2 which includes indexing marks on the work-engaging wall to indicate the midpoint of a workpiece in the jig.

4. A guage plate adapted to fit in the jig, and carrying indexing marks to indicate the midpoint of a work piece in the jig.

5. A jig according to claim 4 which includes a clip for releasably holding the guage plate.

6. A jig according to claim 4 which includes a wing nut and bolt for releasably holding the guage plate.

7. A jig according to claim 1, 2, 4, 5 or 6 in which the angle setting projection is in the shape of a plate having an aligning surface adapted to engage the backup plate on the table.

8. Apparatus according to claim 1 or 2, in which the angle setting projection is adjustable.

9. A jig according to claim 1 or 2 in which the angle setting projection is a screw threaded into a sleeve secured to the work-engaging wall.

10. Apparatus according to claim 9 in which the sleeve is releasably secured to the work-engaging wall.

11. A jig according to claim 1 or 2 in which the angle setting projection is formed integrally with the work-engaging wall.

12. A jig according to claim 11 in which the angle setting projection is a bent portion of the work-engaging wall.

13. A jig according to claim 1 or 2 which includes a clamp on the jig and independent of the table clamp for holding the workpiece in the jig.

14. A jig according to claim 1 or 2 in which the angle-setting projection includes an adjustable plate and a releasable lock for locking the adjustable plate in different positions on the work-engaging wall.
